(19) United States
(12) Patent Application Publication
(10) Pub. No.: US 2004/0089327 A1
(43) Pub. Date: May 13, 2004

(54) Vegetation removal process

(76) Inventor: Robert C. Rajewski, Stettler (CA)

Correspondence Address: THOMPSON LAMBERT, SUITE 703D, CRYSTAL PARK TWO, 2121 CRYSTAL DRIVE, ARLINGTON, VA, 22202

(21) Appl. No.: 10/365,402

(22) Filed: Feb. 13, 2003

(30) Foreign Application Priority Data
Nov. 7, 2002 (CA) 2,411,547

(51) Int. Cl. B08B 7/00

(52) U.S. Cl. 134/34; 134/7; 134/42

(57) ABSTRACT

A method of removing vegetation by running a blaster unit along a utility cut line on which vegetation is growing; and directing a jet of fluidised material at the vegetation at a sufficiently high rate and for a sufficiently long time to kill the vegetation. In one embodiment, the blaster unit is a water blaster unit and the jet of fluidised material is water. In another embodiment, the blaster unit is a sand blaster unit and the jet of fluidised material is sand carried by an air stream.

### BACKGROUND OF THE INVENTION

Control of vegetation on utility cut lines is conventionally carried out either by using saws, other cutting implements, or herbicide. Using chemicals is not environmentally friendly while use of cutting implements is slow and labour intensive. What is needed is an improved method of controlling vegetation growth on cut lines.

### SUMMARY OF THE INVENTION

This invention, in its various independent aspects, provides a method of removing vegetation, the method comprising the steps of running a blaster unit along a utility cut line on which vegetation is growing; and directing a jet of fluidised material at the vegetation at a sufficiently high rate and for a sufficiently long time to kill the vegetation. In one embodiment, the blaster unit is a water blaster unit and the jet of fluidised material is water carried by an air stream. In another embodiment, the blaster unit is a sand blaster unit and the jet of fluidised material is sand carried by an air stream. In another embodiment of the invention, a blaster unit with water jet is used to mow grass in roadside ditches.

These and other aspects of the invention are described in the detailed description of the invention and claimed in the claims that follow.

### BRIEF DESCRIPTION OF THE DRAWINGS

There will now be described preferred embodiments of the invention, with reference to the drawings, by way of illustration only and not with the intention of limiting the scope of the invention, in which:

FIG. 1 is a schematic of a blaster unit according to the invention;

FIG. 2 is a schematic showing a first embodiment of a sand and air mixer for use in the blaster unit of FIG. 1; and

FIG. 3 is a schematic showing a second embodiment of a sand and air mixer for use in the blaster unit of FIG. 1

### DETAILED DESCRIPTION OF PREFERRED EMBODIMENTS

In this patent document, the word “comprising” is used in its non-limiting sense to mean that items following the word in the sentence are included and that items not specifically mentioned are not excluded. The use of the indefinite article “a” in the claims before an element means that one of the elements is specified, but does not specifically exclude others of the elements being present, unless, unless the context clearly requires that there be one and only one of the elements.

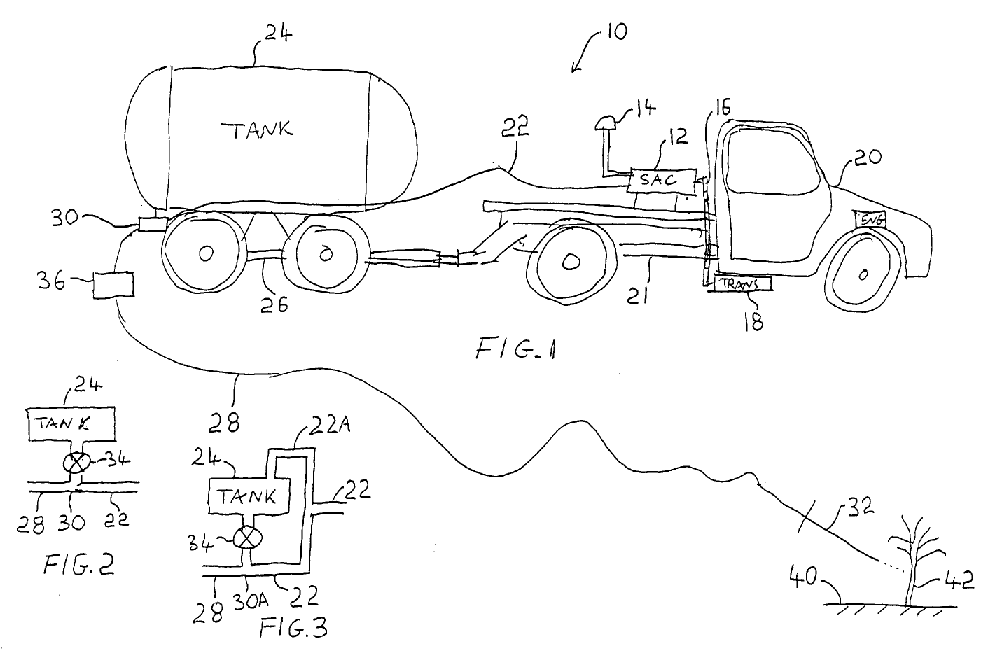

In a method of removing vegetation, a blaster unit 10 is run along a utility cut line 40 on which vegetation 42 is growing. As shown in FIG. 1, the blaster unit 10 may use an air compressor 12 with an air intake 14. The air compressor 12 may be a conventional screw compressor. The gas compressor 12 may be a rotary screw gas compressor available from any of a number of manufacturers such as CompAir LeROI of Sidney, Ohio, USA, or Gardner Denver, Inc. of Quincy, Ill., USA. The air compressor 12 may be driven by belts 16 connected directly to the transmission 18 of a truck 20 on which the air compressor 12 is mounted. Alternatively, the compressor 12 may be mounted directly on the chassis 21 of a truck 20 and driven directly by the shaft of the transmission 18. Other methods of driving the compressor 12 may be used. The truck 20 may be a commercially available 3/4 ton truck with an internal combustion engine ENG generating 180 to 300 hp. General Motors trucks such as the 2500 series, two wheel drive, or Dodge trucks may be used, but any other make with sufficient power and reliability would be suitable.

A blast wand 32 is used to deliver a compressed air stream to the target vegetation. The blast wand 32 is supplied compressed air through hose 22, mixer 30 and jetting hose 28. The compressed air is mixed with cutting material from a tank 24 at the mixer 30. The tank 24 is conveniently mounted on a trailer 26 pulled by the truck 20. The tank 24 may be a sand hopper, in which case the cutting material is sand or other particulate, or a water tank, in which case the cutting material is water or other suitable fluid. The jetting hose 28 is provided with a shut-off valve 36, and terminates at the blast wand 32. The blast wand 32 preferably incorporates a dead man switch (not shown) so that if the operator is no longer attending to the jetting, the flow of fluid will be shut off. Such a switch is conventional in hydrovac applications.

Mixing of cutting material with the compressed air may be accomplished in any of various suitable ways. Two methods are shown in FIGS. 2 and 3. In FIG. 2, mixer 30 includes a venturi so that compressed air flowing along line 22 into line 28 speeds up and the pressure is reduced to draw cutting material from the tank 24 through metering valve 34. In this embodiment, it is not necessary to pressurize tank 24, which reduces the cost of the tank 24 considerably. In FIG. 3, the tank 24 is pressurized with air from the air compressor 12 through hose 22A connected to hose 22 to force cutting material through metering valve 34 into the compressed air stream flowing from hose 22 through mixer 30A. In the embodiment of FIG. 3, the tank 24 must be built to withstand the pressure from the screw compressor 12.

In operation, the air compressor 12 is turned on with the shut-off valve 36 closed. When it is desired to treat vegetation 42, the blast wand 32 is directed at vegetation 42, and the shut-off valve 36 opened. Metering valve 34 is adjusted to provide a desired rate of cutting material flow. The dead man switch on the blast wand 32 is released to blast a jet of fluidized material at target vegetation 42. Once the vegetation 42 is sufficiently damaged, the jet of fluidized material is directed towards further vegetation.

The pressure applied to the tank 24 and the duration of treatment should be sufficient to kill vegetation on the utility cut line. This is generally achieved by girthing the vegetation, which is defined as shattering the outer shell or skin of the vegetation, for example the bark of a tree or shrub, in a complete circle around the vegetation or sufficiently complete circle to kill the tree. The treatment duration will vary depending on the vegetation being treated. The process is suitable for killing trees having a trunk diameter up to about 10 inches, as for example having a diameter from 2 inches to 10 inches, measured at a level about 2 feet from the ground. Girthing a tree by destroying the bark in a complete or nearly complete circle around a tree is an effective way to destroy a tree. Air pressure in the blast hose of 3000 psi has been found adequate, with water flow rate of 10 gallons per minute, or air flow rate of 350 CFM plus variable amounts of aggregrate. However, the amount of pressure or fluid flow used varies depending on the application.

A man lift boom (not shown, but conventional on hydrovac vehicles) may be used to carry the hose 28. Conventional fittings, valves and hoses are used for all components.

The apparatus of the invention may also be used to mow grass in ditches along roadways. In this instance, the tank 24 is a water tank, and a water jet is blasted at the grass to remove it.

A person skilled in the art could make immaterial modifications to the invention described in this patent document without departing from the essence of the invention that is intended to be covered by the scope of the claims that follow.

I claim:

1. A method of removing vegetation, the method comprising the steps of:
running a blaster unit along a utility cut line on which vegetation is growing; and
directing a jet of fluidised material at the vegetation at a sufficiently high rate and for a sufficiently long time to kill the vegetation.

2. The method of claim 1 in which the blaster unit is a water blaster unit and the jet of fluidised material is water carried by an air stream.

3. The method of claim 1 in which the blaster unit is a sand blaster unit and the jet of fluidised material is sand carried by an air stream.

4. The method of claim 1 in which the vegetation has a trunk diameter of between 2 inches and 10 inches measured at a level about 2 feet from the ground.

5. The method of claim 4 in which the vegetation is killed by girthing the vegetation.

6. A method of removing vegetation, the method comprising the steps of:
running a blaster unit along a road side ditch on which grass is growing; and
directing a water jet at the grass at a sufficiently high rate and for a sufficiently long time to kill the vegetation.
